(19) United States
(12) Patent Application Publication
(10) Pub. No.: US 2023/0257043 A1
(43) Pub. Date: Aug. 17, 2023

(54) TRANSPORT DEVICE FOR AND TRANSPORT METHOD FOR TRANSPORTING POWER UNIT MOUNT BODY

(71) Applicant: Honda Motor Co., Ltd., Tokyo (JP)

(72) Inventor: Tsukuru YAMAMURA, Tokyo (JP)

(73) Assignee: Honda Motor Co., Ltd., Tokyo (JP)

(21) Appl. No.: 18/153,367

(22) Filed: Jan. 12, 2023

(30) Foreign Application Priority Data
Feb. 17, 2022 (CN) 202210147948.4

(51) Int. Cl. B62D 65/02

(52) U.S. Cl. CPC B62D 65/026

(57) ABSTRACT

A transport device and a transport method for transporting a power unit mount body are provided. The transport device is for transporting the power unit mount body including a power source, a subframe, and a torque rod connected to the power source and the subframe in a front-rear direction to a lower side of a vehicle frame. The transport device includes a pallet and a transport body. The power unit mount body in a suspended state is placed on the pallet. The transport body transports the pallet on which the power unit mount body is placed to the lower side of the vehicle frame. The pallet includes a clamp mechanism clamping the power source of the power unit mount body in a left-right direction.

### CROSS-REFERENCE TO RELATED APPLICATION

This application claims the priority benefit of Chinese application no. 202210147948.4, filed on Feb. 17, 2022. The entirety of the above-mentioned patent application is hereby incorporated by reference herein and made a part of this specification.

### BACKGROUND

### Technical Field

The disclosure relates to a transport device and a transport method for transporting a power unit mount body. More particularly, the disclosure relates to a transport device and a transport method for transporting a power unit mount body to a lower side of a vehicle frame.

### Description of Related Art

In recent years, construction of safe cities and human settlements has been strengthened in all countries to strengthen inclusive and sustainable urban development, sustainable human settlements planning, and management capacity in all countries. Accordingly, it is necessary to strengthen the provision of safe, affordable, accessible, and sustainable transportation systems to all people in all countries; it is necessary to improve road safety, particularly expansion of public transport; and it is necessary to pay special attention to the needs of persons in vulnerable situations, women, children, persons with disabilities, and the elderly. In the field of transportation, there is an urgent need to take measures to address environmental issues to develop technologies that can improve the convenience and safety of public transportation. For example, in the aspect of various equipment on automated production lines in the vehicle manufacturing industry, it is necessary to improve the safety and convenience in tasks such as assembly and mounting.

In the manufacturing industry of conventional vehicles, for example, Patent Document 1 (Japanese Patent No. 2562485) discloses a mount structure of a power unit as follows: a power unit composed of an engine as a power source and a reducer coupled to the engine is supported on a vehicle frame by mounts arranged at an engine side and a reducer side on the substantial inertia main axis of the power unit, and a subframe mounted on the vehicle frame is connected to the power unit by a substantially horizontal torque rod.

As such, conventionally, since the power unit is connected to the subframe by the torque rod alone, a posture of the power unit is unstable during the task of mounting the mounts at the power source side and the reducer side on the vehicle frame. Accordingly, the task of mounting the mounts at the power source side and the reducer side on the vehicle frame is unlikely.

Further, Patent Document 2 (Japanese Patent Application Laid-Open No. 2008-100676) discloses a power unit mounting and assembling device for mounting the power unit on a vehicle frame. The power unit is mounted on the vehicle frame by sandwiching a mount for bearing a static load of the power unit between the power unit and the vehicle frame and sandwiching a subframe mounted on the vehicle frame between the power unit and the vehicle frame.

Conventionally (e.g., in Patent Document 2), the power unit mounting and assembling device assembles the power unit with the subframe by a temporary fixing jig in the same posture as the assembly state, and the temporary fixing jig is required to be disassembled after the assembly. However, the power unit mounting and assembling device proposed in Patent Document 2 performs assembly for a vehicle model that is provided with a vehicle body front structure including left and right under load path members for connecting the subframe and absorbing impact energy. During the assembly of Patent Document 2, the temporary fixing jig is connected to the left and right under load path members of the subframe to temporarily fix the temporary fixing jig and the power unit, and the temporary fixing jig is removed after the assembly.

Accordingly, the conventional manner of fixing the temporary fixing jig of the mounting and assembly device is not applicable to a vehicle not provided with left and right under load path members (for example, a lightweighted vehicle does not have left and right under load path members). Thus, there is a need for a transport device and a transport method for transporting a power unit mount body that can assemble vehicle models having different types of vehicle body front structures and suppress vibration of the power unit.

The disclosure provides a transport device and a transport method for transporting a power unit mount body that can transport and assemble vehicles having different types of vehicle body front structures and suppress vibration of the power unit during assembly.

### SUMMARY

Disclosed is a transport device for transporting a power unit mount body to a lower side of a vehicle frame, the power unit mount body including a power source, a subframe, and a torque rod connected to the power source and the subframe in a front-rear direction. The transport device includes a pallet and a transport body. The power unit mount body in a suspended state is placed on the pallet. The transport body transports the pallet on which the power unit mount body is placed to the lower side of the vehicle frame. The pallet includes a clamp mechanism clamping the power source of the power unit mount body in a left-right direction.

Furthermore, also disclosed is a transport method for transporting a power unit mount body through the transport device. The transport method includes the following. The power unit mount body in a suspended state is brought close to the pallet. The positioning pin of the pallet is inserted into the positioning hole of the power unit mount body. The power source of the power unit mount body is clamped by the clamp mechanism in the left-right direction. The power unit vmount body in a suspended state is placed on the pallet. The pallet on which the power unit mount body is placed is transported to the lower side of the vehicle frame by the transport body.

### BRIEF DESCRIPTION OF THE DRAWINGS

FIG. 1 is a schematic view of a transport device for transporting a power unit mount body of an embodiment of the disclosure.

FIG. 2A to FIG. 2C are schematic views illustrating a transport process performed in a transport system on a vehicle production line using the transport device of an embodiment of the disclosure.

FIG. 3A to FIG. 3C are schematic views illustrating the power unit mount body mounted to the transport device of FIG. 1.

FIG. 4 is a schematic partially enlarged view of FIG. 3C.

### DESCRIPTION OF THE EMBODIMENTS

Disclosed is a transport device for transporting a power unit mount body to a lower side of a vehicle frame, the power unit mount body including a power source, a subframe, and a torque rod connected to the power source and the subframe in a front-rear direction. The transport device includes a pallet and a transport body. The power unit mount body in a suspended state is placed on the pallet. The transport body transports the pallet on which the power unit mount body is placed to the lower side of the vehicle frame. The pallet includes a clamp mechanism clamping the power source of the power unit mount body in a left-right direction.

According to an embodiment of the disclosure, the clamp mechanism is disposed on the pallet and is utilized to clamp the power source of the power unit mount body in the left-right direction, which can suppress the shaking of the power unit mount body placed on the pallet, so as to improve the stability in assembling the power unit and the subframe to the vehicle frame.

In addition, in an embodiment of the disclosure, the clamp mechanism has an abutting part abutting against the power source. The abutting part is formed into a guiding shape to guide a clamp position of the power source in the left-right direction.

According to the structure, the guiding shape is disposed in the clamp mechanism to guide the power source to be maintained in the clamp position, so that the power source can be clamped in the correct position, further improving the stability in the assembly.

In addition, in an embodiment of the disclosure, the abutting part is formed into an inclined surface inclined from an outer side of the clamp mechanism toward an inner side of the clamp mechanism in an up-down direction.

According to the structure, by disposing the inclined surface, the power source can be relatively conveniently guided to be clamped in the correct position, further improving the stability in the assembly.

In addition, in an embodiment of the disclosure, the abutting part is formed into an L-shape, and abuts against a side end part of the power source in an up-down direction and in the left-right direction.

According to the structure, by disposing the L-shaped abutting part, the power source can be relatively conveniently guided to be clamped in the correct position, and the shaking of the power unit mount body can be suppressed, further improving the convenience and stability in the assembly.

In addition, in an embodiment of the disclosure, the pallet includes a positioning pin, the power unit mount body includes a positioning hole, and the positioning pin is inserted into the positioning hole.

According to the structure, the positioning pin that can guide the power unit mount body to be assembled in the correct position is disposed, which can suppress the shaking of the power unit mount body during assembly, further improving the convenience and stability in the assembly.

Furthermore, also disclosed is a transport method for transporting a power unit mount body through the transport device. The transport method includes the following. The power unit mount body in a suspended state is brought close to the pallet. The positioning pin of the pallet is inserted into the positioning hole of the power unit mount body. The power source of the power unit mount body is clamped by the clamp mechanism in the left-right direction. The power unit mount body in a suspended state is placed on the pallet. The pallet on which the power unit mount body is placed is transported to the lower side of the vehicle frame by the transport body.

According to the transport method, the clamp mechanism is disposed on the pallet and is utilized to clamp the power source of the power unit mount body in the left-right direction, which can suppress the shaking of the power unit mount body placed on the pallet, so as to improve the stability in assembling the power unit and the subframe to the vehicle frame.

In addition, in an embodiment of the disclosure, the transport method further includes the following. The power unit mount body is assembled, in a posture where the power source is clamped by the clamp mechanism in the left-right direction, to the vehicle frame by a mount of the power unit mount body.

According to the transport method, the shaking of the power unit mount body can be suppressed during assembly, further improving the convenience and stability in the assembly.

Based on the foregoing, in the transport device and the transport method for the power unit mount body of the embodiments of the disclosure, during assembly of the power unit mount body including the power source, the subframe, and the torque rod to the vehicle frame, the shaking of the power unit mount body can be suppressed and the stability in the assembly can be improved. In addition, it is not necessary to additionally provide a jig for temporary fixing as conventionally required, so the transport device and the transport method for the power unit mount body of the embodiments of the disclosure can reduce the number of assembly processes, accordingly improving the convenience in the assembly.

Hereinafter, the embodiments of the disclosure will be described based on the drawings. In the embodiments described below, like or corresponding parts are labeled with the same reference numerals and description thereof will not be repeated in some cases. In the embodiments described below, the scope of the disclosure is not necessarily limited to the number, amount, and the like being referred to unless otherwise specified. In addition, in the embodiments below, each constituent element is not necessarily requisite for the disclosure unless otherwise specified. Furthermore, in the case where multiple embodiments are provided below, it is originally intended that the features of the embodiments are combinable with each other as appropriate unless otherwise specified.

A transport device and a transport method for transporting a power unit mount body of the embodiments of the disclosure will be included in the description with reference to the drawings. In the drawings, X represents a fore direction of a front-rear direction of the transport device, Z represents an up direction of an up-down direction of the transport device, and Y represents an inner direction of a width direction of the transport device. In addition, the directions and positions in the description of the disclosure are defined on the premise that the transport device faces forward.

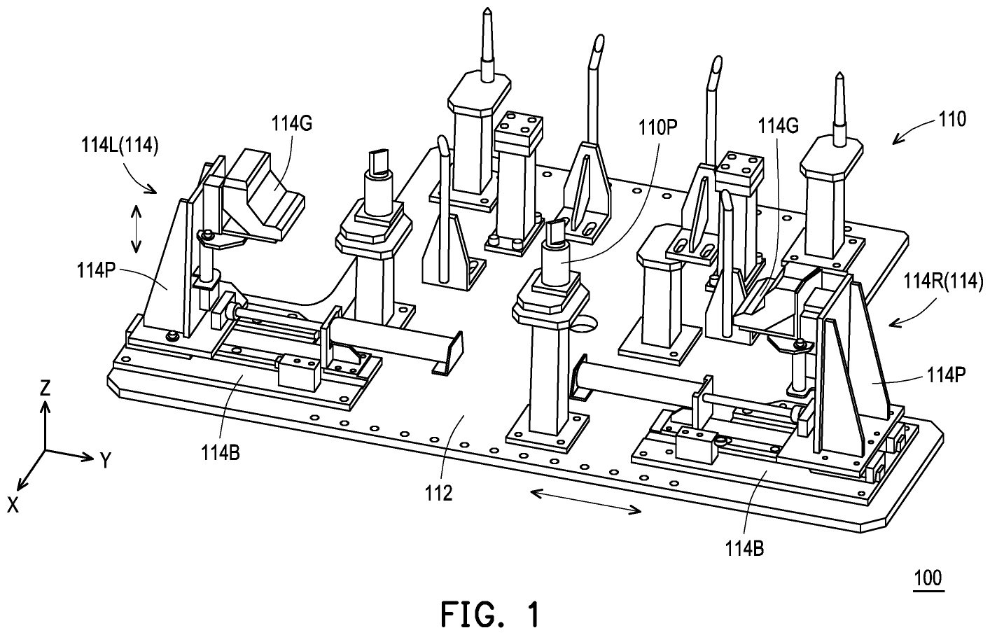

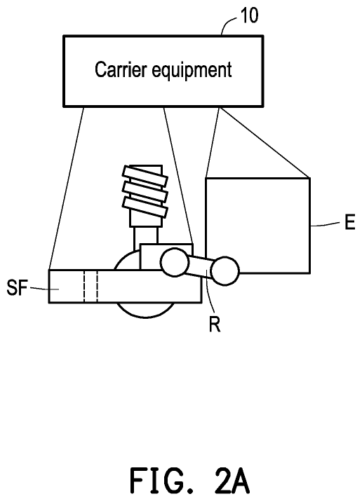

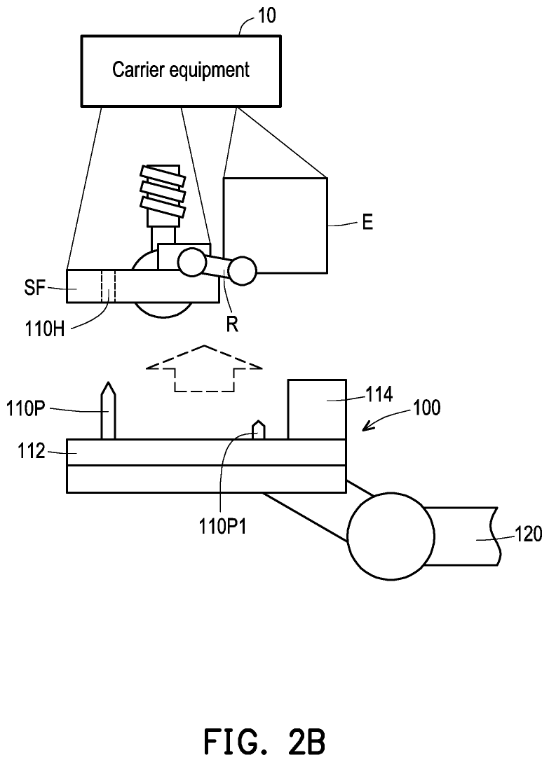

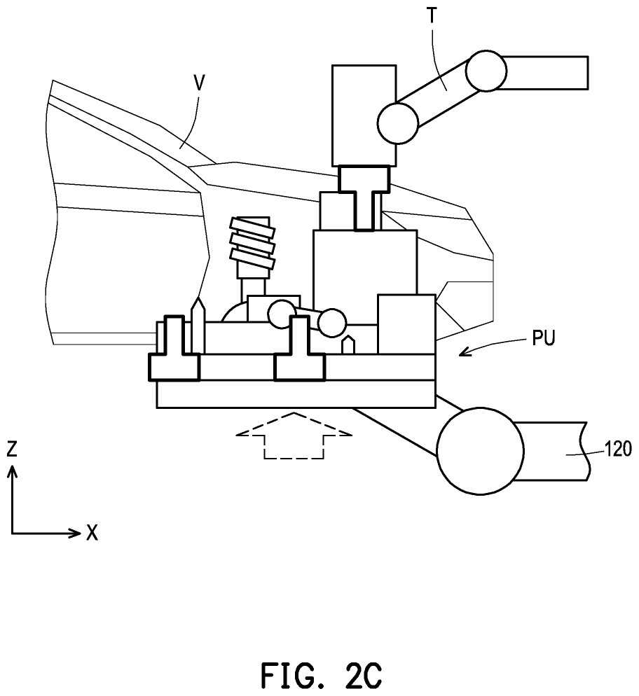

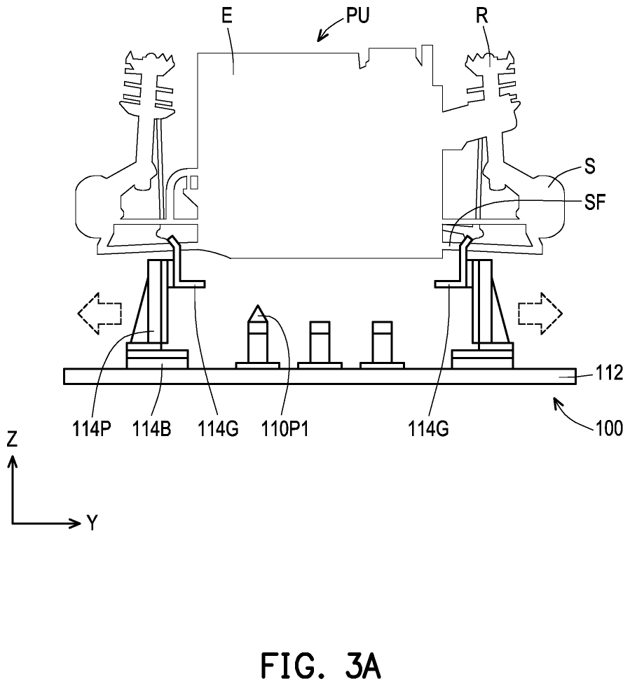

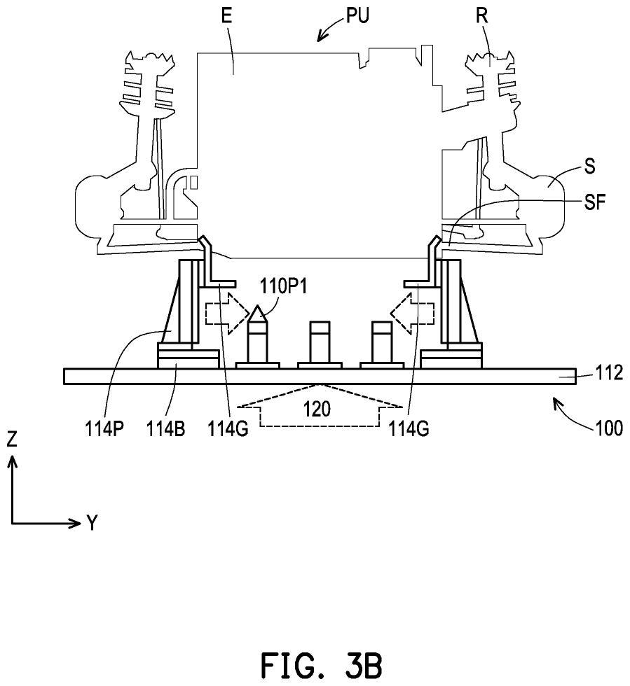

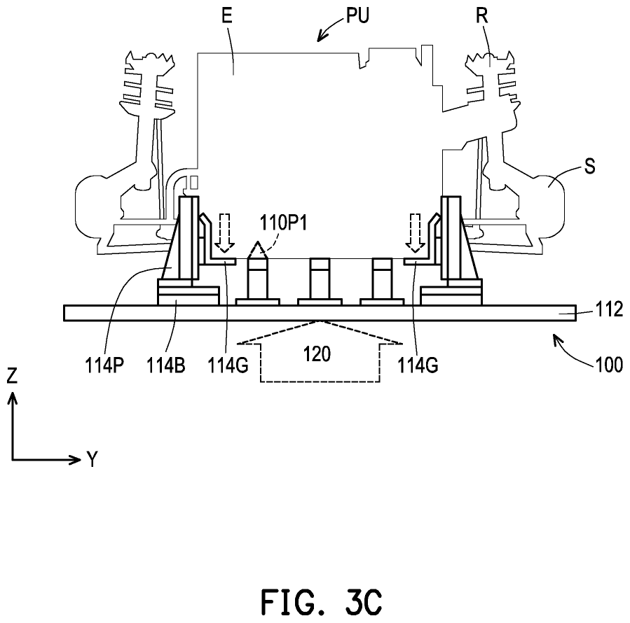

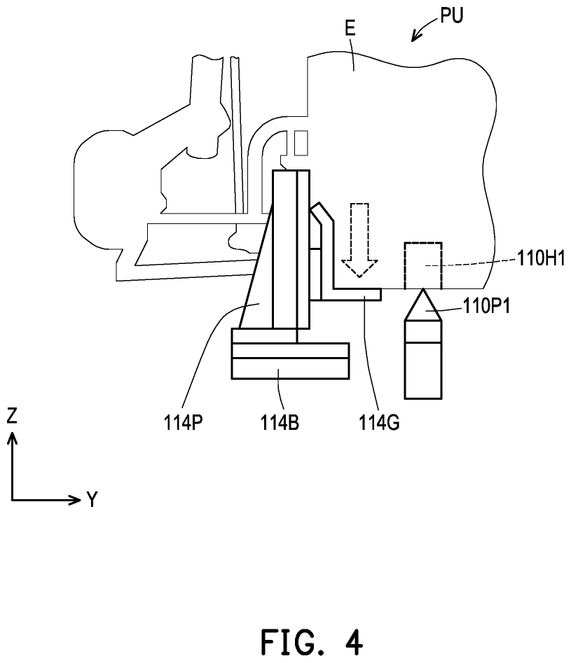

FIG. 1 is a schematic view of a transport device for transporting a power unit mount body of an embodiment of the disclosure. FIG. 2A to FIG. 2C are schematic views illustrating a transport process performed in a transport system on a vehicle production line using the transport device of an embodiment of the disclosure. FIG. 3A to FIG. 3C are schematic views illustrating the power unit mount body mounted to the transport device of FIG. 1. FIG. 4 is a schematic partially enlarged view of FIG. 3C.

In this embodiment, a power unit mount body PU is defined as an assembled part of a power source E (i.e., an engine), a subframe SF, and a torque rod R connected to the power source E and the subframe SF in the front-rear direction. A transport device 100 is a device transporting the power unit mount body PU to a lower side of a vehicle frame and being suitable for a transport system on a vehicle production line.

With reference to FIG. 1, in this embodiment, the transport device 100 includes a pallet 110 and a transport body 120. The transport body 120 is, for example, a robot or a robotic arm for transporting the pallet 110. First, the power unit mount body PU is maintained in a suspended state, and the power unit mount body PU in a suspended state is placed on the pallet 110.

With reference to FIG. 2A to FIG. 2C, the power unit mount body PU in a suspended state is transported by the carrier equipment 10 as shown in FIG. 2A. At this time, the power source E, the subframe SF, and the torque rod R connected to the power source E and the subframe SF in the front-rear direction form the power unit mount body PU in a suspended state.

As shown in FIG. 2B, a process is performed to utilize the transport body 120 to pick up the power unit mount body PU in a suspended state. The pallet 110 includes a positioning pin 110P, and the power unit mount body PU correspondingly includes a positioning hole 110H. The positioning pin 110P may be inserted into the positioning hole 110H. Accordingly, by disposing the positioning pin 110P with a guiding function that can quickly perform the process of placing the power unit mount body PU, the shaking of the power unit mount body PU can be suppressed, and the convenience and stability in the placement process can be improved. In addition, at this time, the power unit mount body PU in a suspended state may swing and shake. Thus, the pallet 110 including a clamp mechanism 114 as described below is utilized to suppress the swing of the power unit mount body PU, so as to suppress the swing of the power source E while the power unit mount body is picked up.

Then, as shown in FIG. 2C, the transport body 120 is driven to be lifted to perform a process of assembling the power unit mount body PU to a vehicle body V (e.g., the vehicle frame of the vehicle body). For example, a nut and a nut runner tool T may be may used for the assembly. Meanwhile, a mount may also be assembled.

A transport method for transporting a power unit mount body according to an embodiment of the disclosure will be described in detail below, in which the shaking of the power unit mount body PU can be suppressed during assembly, improving the convenience and stability in the assembly.

The pallet 110 includes a platform 112 and a clamp mechanism 114 disposed on the upper surface of the platform 112. The clamp mechanism 114 includes a left clamp 114L and a right clamp 114R arranged so that the distance between the left clamp 114L and the right clamp 114R is adjustable. In other words, in the process of clamping the power unit mount body PU, the width of the clamp mechanism 114 (the distance between the left clamp 114L and the right clamp 114R in the left-right direction) may be adjusted to correspond to the width of the power unit mount body PU, so that the clamp mechanism 114 clamps the power source E of the power unit mount body PU in the left-right direction during the assembly.

As shown in FIG. 1, the clamp mechanism 114 is disposed on the upper surface of the pallet 110 and includes the left clamp 114L and the right clamp 114R. In this embodiment, the left clamp 114L and the right clamp 114R each include a bottom base 114B and a support pillar 114P disposed on the bottom base 114B. The support pillar 114P may move relative to the bottom base 114B along the left-right direction to adjust the distance between the left clamp 114L and the right clamp 114R to correspond to the width of the power unit mount body PU.

The left clamp 114L and the right clamp 114R of the clamp mechanism 114 each include an abutting part 114G abutting against (being in contact with) the power source E when the power unit mount body PU is clamped. In this embodiment, the abutting part 114G of the clamp mechanism 114 is formed into a guiding shape to guide a clamp position of the power source E in the left-right direction. As such, the guiding shape is disposed in the clamp mechanism 114 to guide the power source E to be maintained in the clamp position, so that the power source E can be clamped in the correct position, further improving the stability in the assembly.

As shown in FIG. 1, for example, the contact surface of the abutting part 114G is formed in a shape substantially corresponding to the contour of the corner part at the outer side of the power source E to increase stability. For example, the abutting part 114G is formed into an inclined surface inclined from an outer side of the clamp mechanism 114 toward an inner side of the clamp mechanism 114 (e.g., the side where the left clamp 114L and the right clamp 114R face each other) in the up-down direction, so that the power unit mount body PU can be smoothly guided during the process of mounting the power unit mount body PU on the pallet 110. As such, by disposing the inclined surface, the power source E can be relatively conveniently guided to be clamped in the correct position, further improving the stability in the assembly.

In addition, in this embodiment, the abutting parts 114G of the left clamp 114L and the right clamp 114R are disposed above the support pillar 114P, and are disposed to be movable relative to the upper surface of the pallet 110 along the up-down direction, so as to adjust the mounting position of the power unit mount body PU in the up-down direction. The abutting part 114G may be formed into, for example, a substantial L-shape when viewed from the front side of the pallet 110. The abutting part 114G abuts against a side end part of the power source E (i.e., the corner portion of the outer side of the power source E) in the up-down direction and in the left-right direction. As such, by disposing the abutting part 114G in an L-shape, while the contact surface of the abutting part 114G is in contact with the side of the side end part of the power source E in the up-down direction during clamping, it is also possible to be in contact with the bottom of the side end part of the power source E in the left-right direction. Contact with the surfaces intersecting in at least two directions can relatively conveniently guide the power source E to be clamped in the correct position, and suppress the shaking of the power unit mount body, further improving the convenience and stability in the assembly.

In this embodiment, the clamp mechanism 114 is disposed on the pallet 110 and is utilized to clamp the power source E of the power unit mount body PU in the left-right direction, which can suppress the swing or shaking of the power unit mount body PU placed on the pallet 110, so as to improve the stability in assembling the power source E and the subframe SF to the vehicle frame. While the power unit mount body PU in a suspended state is maintained in a posture of being placed on the pallet 110, the power unit mount body PU may be firmly clamped by the clamp mechanism 114 in the left-right direction and maintained in an assemblable posture. In other words, the power unit mount body PU is assembled to the vehicle frame in a posture where the clamp mechanism 114 firmly clamps the power source E from both sides. Therefore, when the power unit mount body PU including the power source E, the subframe SF, and the torque rod R is assembled to the vehicle frame, the shaking of the power unit mount body PU can be suppressed, improving the stability in the assembly. In addition, it is not necessary to additionally provide a jig for temporary fixing as conventionally required, so the number of assembly processes can be reduced, accordingly improving the convenience in the assembly.

In this embodiment, as shown in FIG. 1 and FIG. 3A to FIG. 3C, to place the power unit mount body PU on the pallet 110 relatively quickly and stably to facilitate subsequent transport, the pallet 110 may further include a positioning pin 110P1 in addition to the positioning pin 110P, and the power unit mount body PU may further correspondingly include a positioning hole 110H1. The positioning pin 110P1 may be inserted into the positioning hole 110H1. As such, the positioning pin 110P1 that can guide the power unit mount body PU to be assembled in the correct position is disposed, which can suppress the shaking of the power unit mount body PU during assembly, further improving the convenience and stability in the assembly.

During the process of mounting the power unit mount body PU on the pallet 110, the process of placing the power unit mount body PU in a suspended state on the pallet 110 can be seen as shown in FIG. 2B. During this process, the positioning pin 110P of the pallet 110 is inserted into the positioning hole 110H of the power unit mount body PU, and the power unit mount body PU is moved in a suspended state in between the left clamp 114L and the right clamp 114R of the clamp mechanism 114, so that the power source E is clamped in the left-right direction. Accordingly, alignment between the pallet 110 and the power unit mount body PU can be quick and convenient.

To be more specific, in this embodiment, as shown in FIG. 2B, first, the power unit mount body PU in a suspended state is brought close to the pallet 110 (the pallet 110 is brought close to the bottom side of the power unit mount body PU in a suspended state), so that the power unit mount body PU in a suspended state is located between the left clamp 114L and the right clamp 114R above the platform 112. At this time, the distance between the left clamp 114L and the right clamp 114R is appropriately adjusted so as to position the power unit mount body PU in a clamp position where the power source E is clamped in the left-right direction. In other words, the left clamp 114L and the right clamp 114R are moved in a direction away from each other (alignment in the left-right direction is adjusted).

As shown in FIG. 3B, when the power unit mount body PU is positioned in the clamp position between the left clamp 114L and the right clamp 114R, the transport body 120 is utilized to move the pallet 110 upward in the up-down direction (alignment in the up-down direction is adjusted), so that the power unit mounting body PU is in the correct clamp position in the up-down direction. Then, the distance between the left clamp 114L and the right clamp 114R is adjusted by fine-tuning to the correct clamp position (alignment in the left-right direction is fine-tuned). In other words, the left clamp 114L and the right clamp 114R are moved in a direction to be close to each other.

As shown in FIG. 2B, when the power unit mount body PU is positioned in the correct clamp position where the power unit mount body PU may be clamped by the left clamp 114L and the right clamp 114R, a process of inserting the positioning pin 110P of the pallet 110 into the positioning hole 110H of the power unit mount body PU is performed. In other words, the transport body 120 is utilized to move the pallet 110 upward in the up-down direction (alignment between the positioning pin 110P and the positioning hole 110H is adjusted), and the abutting part 114G of the clamp mechanism 114 is linked with the power unit mount body PU to move downward along the support pillar 114P in the up-down direction (alignment between the positioning pin 110P and the positioning hole 110H is fine-tuned) until the positioning pin 110P of the pallet 110 is inserted into the positioning hole 110H of the power unit mount body PU. Then, a process of firmly clamping the power source E in the left-right direction and a process of placing the power unit mount body PU are performed. The power source E of the power unit mount body PU is clamped in the left-right direction, and the power unit mount body PU in a suspended state is placed on the pallet 110. As such, the process of mounting the power unit mount body PU on the pallet 110 is completed.

Then, the transport body 120 may be utilized to transport the pallet 110 on which the power unit mount body PU is placed to the lower side of the vehicle frame for subsequent assembly (not shown). For example, by a mount S of the power unit mount body PU, the power unit mount body PU may be assembled to the vehicle frame in a posture where the power source E is clamped by the clamp mechanism 114 in the left-right direction. Because of the alignment by the clamp mechanism 114 and the positioning pin 110P1, subsequent assembly can be performed in a stable posture.

Besides, in this embodiment, in designing the contact surface of the abutting part 114G of the clamp mechanism 114, tolerance in the size and the shape of the structure may be designed depending on the actual requirements. For example, values of the tolerance may be designed so that the optimal balance is achieved between the precision requirements during manufacturing and the effects achievable during assembly. In designing the positioning pin 110P on the pallet 110, tolerance in the size and the shape of the structure thereof may be designed depending on the actual requirements (for example, according to the structure of the positioning hole 110H on the power unit mount body PU). The tolerance value may be designed so that the optimal balance is achieved between the precision requirements during manufacturing and the effects achievable during assembly. Similarly, as shown in FIG. 4, in designing the positioning pin 110P1 on the pallet 110, tolerance value may also be designed according to the positioning hole 110H1 on the power unit mount body PU so that the optimal balance is achieved.

In summary of the foregoing, in the transport device and the transport method for transporting a power unit mount body of the embodiments of the disclosure, while the power unit mount body in a suspended state is maintained in a posture of being placed on the pallet, the power unit mount body may be firmly clamped by the clamp mechanism in the left-right direction and maintained in an assemblable posture. Accordingly, when the power unit mount body including the power source, the subframe, and the torque rod is assembled to the vehicle frame, the shaking of the power unit mount body can be suppressed, and the stability in the assembly can be improved. In addition, it is not necessary to additionally provide a jig for temporary fixing as conventionally required, so the transport device and the transport method for transporting a power unit mount body of the embodiments of the disclosure can reduce the number of assembly processes, accordingly improving the convenience in the assembly.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A transport device for transporting a power unit mount body to a lower side of a vehicle frame, the power unit mount body comprising a power source, a subframe, and a torque rod connected to the power source and the subframe in a front-rear direction, and the transport device comprising:
a pallet, wherein the power unit mount body in a suspended state is placed on the pallet; and
a transport body transporting the pallet on which the power unit mount body is placed to the lower side of the vehicle frame,
wherein the pallet comprises a clamp mechanism clamping the power source of the power unit mount body in a left-right direction.

2. The transport device according to claim 1, wherein the clamp mechanism comprises:
an abutting part abutting against the power source, the abutting part formed into a guiding shape to guide a clamp position of the power source in the left-right direction.

3. The transport device according to claim 2, wherein the abutting part is formed into an inclined surface inclined from an outer side of the clamp mechanism toward an inner side of the clamp mechanism in an up-down direction.

4. The transport device according to claim 2, wherein the abutting part is formed into an L-shape, and abuts against a side end part of the power source in an up-down direction and in the left-right direction.

5. The transport device according to claim 1, wherein the pallet comprises a positioning pin, the power unit mount body comprises a positioning hole, and the positioning pin is inserted into the positioning hole.

6. A transport method for transporting a power unit mount body through the transport device according to claim 5, the transport method comprising:
bringing the power unit mount body in a suspended state close to the pallet;
inserting the positioning pin of the pallet into the positioning hole of the power unit mount body;
clamping, by the clamp mechanism, the power source of the power unit mount body in the left-right direction;
placing the power unit mount body in a suspended state on the pallet; and
transporting, by the transport body, the pallet on which the power unit mount body is placed to the lower side of the vehicle frame.

7. The transport method according to claim 6, further comprising:
assembling, by a mount of the power unit mount body, the power unit mount body in a posture where the power source is clamped by the clamp mechanism in the left-right direction to the vehicle frame.
